(19) United States
(12) Patent Application Publication
(10) Pub. No.: US 2022/0414445 A1
(43) Pub. Date: Dec. 29, 2022

(54) NEURAL NETWORKS WITH ANALOG AND DIGITAL MODULES

(71) Applicant: International Business Machines Corporation, Armonk, NY (US)

(72) Inventors: Malte Johannes Rasch, Chappaqua, NY (US); Mattia Rigotti, Basel (CH)

(21) Appl. No.: 17/362,684

(22) Filed: Jun. 29, 2021

(51) Int. Cl. G06N 3/063; G06N 3/04; G06N 3/08

(52) U.S. Cl. CPC G06N 3/0635; G06N 3/04; G06N 3/08

(57) ABSTRACT

A neural network includes a plurality of analog arrays comprise all synaptic weights of the neural network. The neural network also includes digital modules that are co-trained along with the plurality of analog arrays. The digital modules are intermittently connected and intermittently activated when the neural network is in production. When activated and connected, the digital modules may correct weights of the analog arrays.

### BACKGROUND

Neural networks are computational algorithms that are configured to set (and subsequently update) weights between various associations within the algorithm such that the algorithm improves at classifying and/or “predicting” outputs for a given input. Neural networks comprise nodes or “neurons” across numerous layers, included an input layer where input is received, an output layer at which an output/classification/prediction of the neural network is provided, and one or more “hidden” layers between the input and output layer. A neural network that includes two or more hidden layers may generally be referred to as a “deep” neural network, as generally speaking the utility of a neural network may increase as the number of hidden layers increase. The weights may include logical assessments conducted between neurons as the algorithm tracks along the layers of the neural network. In this way, a neural network is created to approximate the way that the human brain works. Given the success that neural networks have met when deployed, there are increasing efforts to optimize performance so that the abilities of neural networks may be further leveraged.

### SUMMARY

Aspects of the present disclosure relate to a method, system, and computer program product relating to using both analog arrays as well as sparsely connected and activated digital modules to run a neural network. For example, a system includes a plurality of analog arrays that comprise a neural network, and a plurality of digital modules that is co-trained along with the plurality of analog arrays. The analog arrays and digital modules of the system may be deployed together when the neural network is put into production. The digital modules are intermittently connected and/or activated within the neural network upon deployment

For another example, a method includes training a plurality of analog arrays to comprise a neural network. The method further includes co-training a plurality of digital modules along with the plurality of analog arrays in generating the neural network. The digital modules are intermittently connected within the neural network. A system and computer product configured to perform the above method are also disclosed.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a conceptual diagram of an example neural network in which a controller may intermittently connect and/or activate digital modules in a neural network to correct weights of the neural network when in an production environment.

FIG. 2 depicts a conceptual box diagram of example components of the controller of FIG. 1.

FIG. 3 depicts an example flowchart by which the controller of FIG. 1 may sparsely connect and/or activate digital modules of a neural network.

While the invention is amenable to various modifications and alternative forms, specifics thereof have been shown by way of example in the drawings and will be described in detail. It should be understood, however, that the intention is not to limit the invention o the particular embodiments described. On the contrary, the intention is to cover all modifications, equivalents, and alternatives falling within the spirit and scope of the invention.

### DETAILED DESCRIPTION

Aspects of the present disclosure relate to neural network structures, while more particular aspects of the present disclosure relate to intermittently connecting and/or activating digital modules within a neural network. While the present disclosure is not necessarily limited to such applications, various aspects of the disclosure may be appreciated through a discussion of various examples using this context.

Machine learning algorithms such as neural networks are becoming increasingly popular, as the impressive capabilities of these neural networks are growing and becoming more widely known. Conventional neural networks can be generally divided into two categories; a first category that utilizes analog arrays to create a neural network to, and a second category that utilizes digital modules. Conventional neural networks consisting of analog arrays may be capable of performing matrix-vector products in real-time on a functionally constant basis, regardless of the size of the matrix. As a result of this, conventional neural networks consisting of analog arrays can have a dramatically increased speed as well as have better power efficiency metrics (e.g., as compared to the same neural network with the same weights executing the same operations using digital modules). However, by virtue of using analog arrays, such conventional neural networks typically have lower accuracy than a conventional digital counterpart as a result of quantization noise (generally referred to herein as “noise”). As such, conventional systems are forced to choose either accuracy or efficiency and speed, as it is not feasible to have all three within a conventional neural network.

Some conventional neural networks look to address such problems by training analog arrays alongside digital modules, such that weights with noise from the analog arrays may be identified/corrected during training of the conventional neural networks by the digital modules. Once fully trained, the digital modules are removed from the neural network and the fully trained analog arrays are deployed into production. As used herein, production (otherwise referred to herein as a “production environment”) may be a computing environment in which a neural network or other machine learning model is facing “real” data (e.g., data directly from customers and/or end users of the neural network), such that the neural network provides output/classifications/predictions directly to these customers and/or end users (e.g., as compared to a training environment in which the neural network receives cultivated training data for classification). However, as would be understood by one of ordinary skill in the art, minimizing noise is not purely a goal for training (though it is a primary goal at this time), but that this may be a goal after deployment to the production environment as well. Therefore, while conventional neural networks that train analog arrays with digital assistance may improve a level of accuracy of the conventional neural network during training, this accuracy is liable (if not likely) to falter once the conventional neural network deployed to production (e.g., especially given the typically unpredictable nature of production data as compared to training data, which may be more susceptible to noise).

Accordingly, aspects of this disclosure may solve or otherwise address these technical problems of conventional neural networks. For example, aspects of this disclosure are related to a neural network that comprises both analog arrays and also digital modules, where the digital modules are intermittently connected and activated within the neural network. The digital modules may be used to correct weights of the analog arrays. The digital modules may be activated and/or connected to various neurons of the analog array in response to various criterion (e.g., an accuracy dropping, an amount of power being available, a timer being satisfied, etc.) being met. Computing components (e.g., a computing device that includes a processing unit executing instructions stored on a memory, and/or logic gates that conditionally connect and/or activate digital modules as described herein) may provide some or all of this functionality of managing the digital module activation and connection, these computing components herein referred to as a controller. In this way, aspects of this disclosure are related to performing most computation of a neural network in analog, therein “adding in” a relatively small amount of digital computation in order to satisfy a desired level of performance (e.g., as measured in both accuracy of output and energy efficiency required).

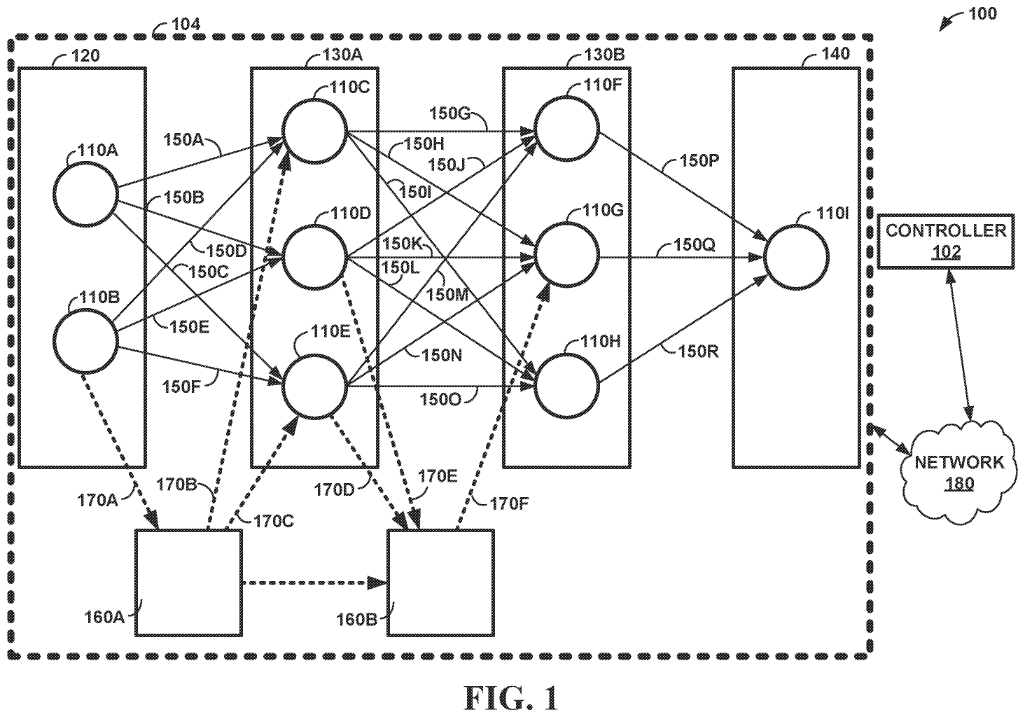

For example, FIG. 1 depicts production environment 100 in which controller 102 manages neural network 104. Neural network 104 includes neurons 110A-110I (collectively, “neurons 110”) across a plurality of lavers 120, 130A, 130B, 140 of neural network 104. Specifically, neural network 104 may include input layer 120, hidden layers 130A, 130B (collectively, “hidden layers 130”), and output layer 140. The specific size and configuration of neural network 104 (e.g., the specific number of neurons 110 and hidden layers 130) as depicted in FIG. 1 is provided for purposes of illustration only, and one of ordinary skill in the art would understand that smaller and larger neural networks 104 are consistent with aspects of this disclosure.

Aspects of this disclosure are related to configuring neural network 104 such that each of neurons 110 across input layer 120, hidden layers 130, and output layer 140 are realized via analog arrays as are known to one of ordinary skill in the art. In this way, neural network 104 may be generated such that all synaptic weights (e.g., the entirety of the synaptic matrix) realized exclusively via analog arrays. Synaptic weights are conceptually depicted as connections 150A-150R (collectively, “connections 150”) within neural network 104, where each of connections 150 is associated with respective weights between respective neurons 110.

Further, aspects of the disclosure are related to digital modules 160A, 160B (collectively, “digital modules 160”) within neural network 104. Though only two digital modules 160 are depicted within neural network 104 for purposes of illustration, more or less digital modules 160 are possible in other examples. For example, there may be a one-to-one ratio between digital modules 160 and layers 120, 130, 140 of neural network 104. For another example, there may be a one-to-one ratio between digital modules 160 and neurons 110 of neural network 104.

Controller 102 may be configured to activate and/or connect digital modules 160 within neural network 104. Controller 102 may activate and/or connect digital modules 160 in response to various criterion. For example, controller 102 may be configured to activate and/or connect digital modules 160 in response to detecting that a performance criterion of neural network 104 has failed. This performance criterion may include an accuracy of neural network 104. Controller 102 may verify whether a classification/prediction of neural network 104 is accurate from feedback from a human, and/or feedback from an external system that later provides an actual value that was predicted by neural network 104 (e.g., such as a situation in which neural network 104 predicts the weather, after which controller 104 receives weather information and compares it against the predicted weather).

In this way, controller 102 may identify whether each record received at input layer 120 of neural network 104 was accurately classified/predicted when output by output layer 140. If controller 102 determines that neural network is classifying/predicting at worse than a threshold level, controller 102 may therein connect/activate one or more digital modules 160. A threshold level may include a predetermined percentage of incoming records. This threshold percentage may be any percentage, such as 90%, 95%, or 100% (e.g., such that in some examples controller 102 may activate/connect one or more digital modules 160 in response to a single record being misclassified by neural network 104).

Beyond a performance criterion, controller 102 may additionally or alternatively activate and/or connect one or more digital modules 160 in response to an energy criterion being satisfied. As described herein, digital modules 160 tend to require more energy than analog arrays. As such, controller 102 may be configured to determine when an amount of energy being used by neural network 104, used in production environment 100, and/or used by a computing system hosting production environment 100, falls below a threshold. When the detected amount of energy being consumed falls below a threshold, this may indicate that there is “spare” energy which may be used by digital modules 160 (e.g., used without causing a performance or efficiency of any other computer component of production environment 100 to drop or otherwise be underserved). As such, when controller 102 detects that an amount of energy being consumed by one or more components within (or otherwise associated with) production environment 100 drops below a energy criterion, controller 102 may activate and/or connect one or more digital modules 160 so that digital modules 160 may correct weights of one or more analog arrays of neural network 104.

Further, in some examples controller 102 may connect and/or activate digital modules 160 based on a schedule. For example, controller 102 may connect and/or activate digital modules 160 once every few minutes to correct weights of one or more analog arrays, after which controller 102 disconnects and/or deactivates digital modules 160. Put differently, controller 102 may wait for a predetermined waiting period to elapse before controller 102 does (or evaluates whether to) connect and/or activate one or more digital modules 160.

In certain examples, controller 102 may use two or more of these criterion to control when to connect and/or activate digital modules 160. For example, controller 102 may only activate and connect digital modules 160 in response to detecting that both neural network 104 has failed a performance criterion and also that an energy criterion has been satisfied. By waiting for two or more criterion to be satisfied before activating and connecting digital modules 160, controller 102 may improve an efficiency and accuracy of neural network 104.

As discussed herein, controller 102 activates and connects digital modules 160 to correct weights from analog arrays. For example, controller 102 may detect that an energy consumption related to production environment 100 falls below a threshold and also that an accuracy of neural network 104 falls below a threshold. In response to this, controller 102 may activate both digital modules 160 (e.g., provide power to digital modules 160). In addition to activating digital nodules 160, controller 102 may activate connections 170A-170F (collectively, “connections 170”) between digital modules 160 that connect digital modules 160 to some neurons 110 of some layers 120, 130, 140. The provided connections 170 are depicted for purpose of example only to illustrate an example of some connections 170 that controller 102 may connect—it is to be understood that in other examples a controller 102 may connect more or less neurons 110 to digital modules 160.

For example, as depicted, controller 102 may connect digital modules 160A to neuron 110B from input layer 120, as well as neurons 110C, 110E from hidden layer 130A. Further, controller 102 may connect digital modules 160B to neurons 110D, 110E from hidden layer 130A, as well as neuron 110G from hidden layer 130B. These neurons 110 and layers 120, 130, 140 are selected for purposes of example only, as controller 102 may connect other/more/less neurons 110 to digital modules 160 in other examples. Once connected, controller 102 may use values from digital modules 160 to correct the synaptic weights of the synaptic matrix of neural network 104 (e.g., by changing synaptic weights of one or more connections 150).

Controller 102 may only activate each given digital module 160 in response to determining that this digital module 160 is associated with an inaccuracy. Further, controller 102 may only connect one of digital modules 160 to respective neurons 110 in response to detecting that synaptic weights associated with these respective neurons 110 are associated with an inaccuracy. For example, as depicted in FIG. 1, controller 102 may connect digital module 160A with neurons 110B, 110C, 110E, in response to detecting that connections 150D, 150F are associated with potentially inaccurate classifications (e.g., such that synaptic weights of connections 150D, 150F may need to be corrected).

Specifically, controller 102 may execute operations on matrices of synaptic weights to fine tune neural network 104 using digital modules 160. For example, controller 102 may compile all weights of analog connections 150 into a matrix, and then multiply this matrix with a matrix of synaptic weights generated digitally (e.g., via connections 170 and digital module 160). For example, controller 102 may fine tune synaptic weights using digital modules 160 by, e.g., training a rank-1 matrix to obtain task specific weights, potentially via calculations such as:

yₙ=ϕ(W^{T}xₙ)

yₙ=ϕ((Wosr^{T})^{T}xₙ)

yₙ=ϕ(W^{T}(xₙ o sr)o rᵢ)

where W is the matrix of analog weights, sr^{T} is a matrix of values of digital modules 160, o is the Kronecker product, and Wosr^{T} are the task specific weights. In this way, controller 102 may convert noisy analog weights W into accurate digitally trained weights W^{d}, upon which controller 102 may train a rank-1 correction rs^{T} with a distillation cost to reproduce the original outputs obtained with W^{d}, such as with the following calculation:

ϕ(W^{d}xₙ)≈ϕ((W o sr^{T})xₙ)

Controller 102 may cause digital modules 160 to be active in response to conditions related to other digital modules 160. For example, controller 102 may cause digital modules to be active depending upon whether downstream digital modules 160 are active. Specifically, m₁ might indicate digital module 160 activation, where if c_{1→k}(m₁) is negative, then the downstream digital module 160 is deactivated. In such a case, controller 102 may only activate a given digital module 160 in response to all upstream digital modules 160 have c_{1→k}(m₁)>0 (e.g., all upstream digital modules 160 are active). Where upstream digital modules 160 have a negative c_{1→k}(m₁) value, the given digital module 160 is deactivated (if currently active). In such examples, controller 104 may train the condition function c_{1→k}(m₁) end-to-end with the whole architecture (e.g., to maximize a performance of neural network 104 under sparsity constraints), and/or the condition c_{1→k}(m₁) may be determined by a single fixed criterion. For example, digital modules 160 may be activated downstream if activations deviate a predetermined operation range, and/or digital modules 160 may be activated if downstream softmax activations reach a threshold level of confidence.

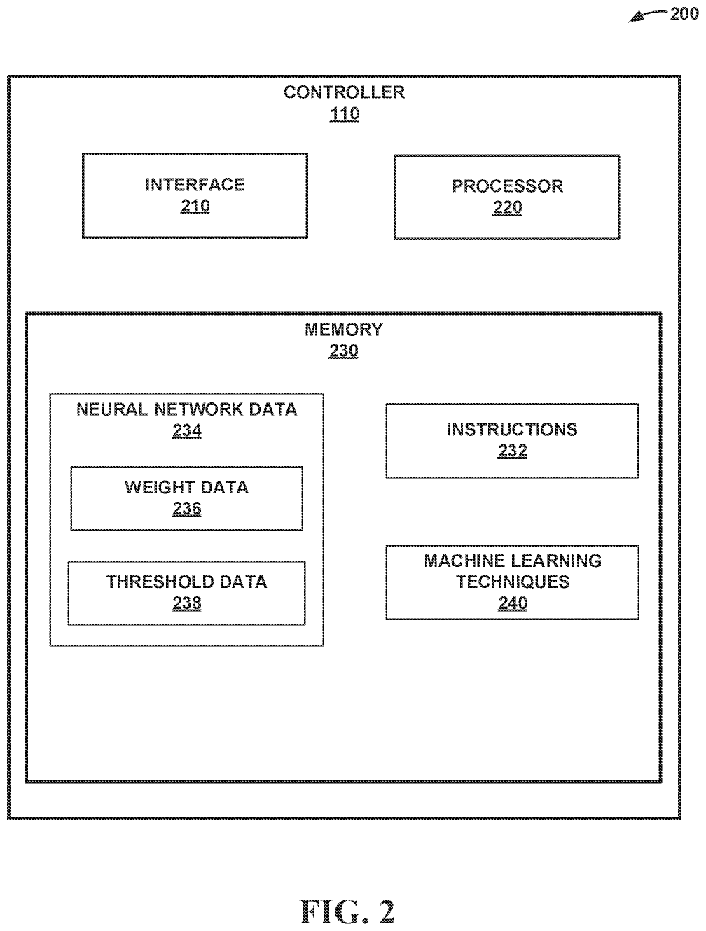

In some examples, the functionality of controller 102 may be provided by a standalone computing system (e.g., such as is depicted in FIG. 2), where this controller 102 interacts with neural network 104 via network 180. Network 180 may include one or more computer communication networks. An example network 180 can include the Internet, a local area network (LAN), a wide area network (WAN), a wireless network such as a wireless LAN (WLAN), or the like. Network 180 may comprise copper transmission cables, optical transmission fibers, wireless transmission, routers, firewalls, switches, gateway computers and/or edge servers. A network adapter card or network interface in each computing/processing device (e.g., controller 102, computers that host production environment 100) may receive messages and/or instructions from and/or through network 180 and forward the messages and/or instructions for storage or execution or the like to a respective memory or processor of the respective computing/processing device. Though network 180 is depicted as a single entity in FIG. 1 for purposes of illustration, in other examples network 180 may include a plurality of private and/or public networks over which controller 102 may manage connectivity as described herein. In other examples (not depicted), controller 102 may be provided as functionality within the same computing device (or computing devices) that host/provide neural network 104.

As described above, controller 102 may be part of a computing device that includes a processor configured to execute instructions stored on a memory to execute the techniques described herein. For example, FIG. 2 is a conceptual box diagram of such computing system 200 of controller 102. While controller 102 is depicted as a single entity (e.g., within a single housing) for the purposes of illustration, in other examples, controller 102 may include two or more discrete physical systems (e.g., within two or more discrete housings). Controller 102 may include interfaces 210, processor 220, and memory 230. Controller 102 may include any number or amount of interface(s) 210, processor(s) 220, and/or memory(s) 230.

Controller 102 may include components that enable controller 102 to communicate with (e.g., send data to and receive and utilize data transmitted by) devices that are external to controller 102. For example, controller 102 may include interface 210 that is configured to enable controller 102 and components within controller 102 (e.g., such as processor 220) to communicate with entities external to controller 102. Specifically, interface 210 may be configured to enable components of controller 102 to communicate with components of neural network 104 or the like. Interface 210 may include one or more network interface cards, such as Ethernet cards and/or any other types of interface devices that can send and receive information. Various numbers of interfaces may be used to perform the described functions according to particular needs.

As discussed herein, controller 102 may be configured to intermittently connect and activate digital modules 160 to correct weights of analog arrays of neural network 104. Controller 102 may utilize processor 220 to thusly manage weights of neural network 104. Processor 220 may include, for example, microprocessors, digital signal processors (DSPs), application specific integrated circuits (ASICs), field-programmable gate arrays (FPGAs), and/or equivalent discrete or integrated logic circuits. Two or more of processor 220 may be configured to work together to intermittently connect and activate digital modules 160 accordingly.

Processor 220 may intermittently connect and activate digital modules 160 to correct weights of neural network 104 according to instructions 232 stored on memory 230 of controller 102. Memory 230 may include a computer-readable storage medium or computer-readable storage device. In some examples, memory 230 may include one or more of a short-term memory or a long-term memory. Memory 230 may include, for example, random access memories (RAM), dynamic random-access memories (DRAM), static random-access memories (SRAM), magnetic hard discs, optical discs, floppy discs, flash memories, forms of electrically programmable memories (EPROM), electrically erasable and programmable memories (EEPROM), or the like. In some examples, processor 220 may intermittently connect and activate digital modules 160 to correct weights of analog arrays of neural network 104 as described herein according to instructions 232 of one or more applications (e.g., software applications) stored in memory 230 of controller 102.

In addition to instructions 232, in some examples gathered or predetermined data or techniques or the like as used by processor 220 to manage a connectivity and activation of digital modules 160 as described herein may be stored within memory 230. For example, memory 230 may include information described above as controller 102 related to neural network 104. For example, as depicted in FIG. 2, memory 230 may include neural network data 234, which includes weight data 236 and threshold data 238. Weight data 236 may include any of the detected synaptic weights, any of the calculations used to correct/convert detected weights, or the like. Further, threshold data 238 may include thresholds at which controller 102 connects and/or activates one or more digital modules 160. For example, threshold data 238 may include an accuracy threshold criterion which, if failed, results in controller 102 to connect and activate one or more digital modules 160 to correct weights of neural network 104. For another example, threshold data 238 may include an energy threshold criterion which, if energy falls below, may cause controller 102 to connect and activate digital modules 160.

Memory 230 may further include machine learning techniques 240 that controller 102 may use to improve a process of connecting and/or activating digital modules 160 to correct weights of neural networks 104 as discussed herein over time. Machine learning techniques 240 can comprise algorithms or models that are generated by performing supervised, unsupervised, or semi-supervised training on a dataset, and subsequently applying the generated algorithm or model to determine to connect and/or activate digital modules 160. For example, using machine learning techniques 240, controller 102 may update one or more thresholds saved in threshold data 238 and/or weight calculations stored within weight data 236 to improve a process of determining when to connect and activate one or more digital modules 160 as described herein.

Machine learning techniques 240 can include, but are not limited to, decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, and/or other machine learning techniques.

For example, machine learning techniques 240 can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models. Gaussian naïve Bayes, multinomial naïve Bayes, averaged one-dependence estimators (AODE), Bayesian network (BN), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning algorithms.

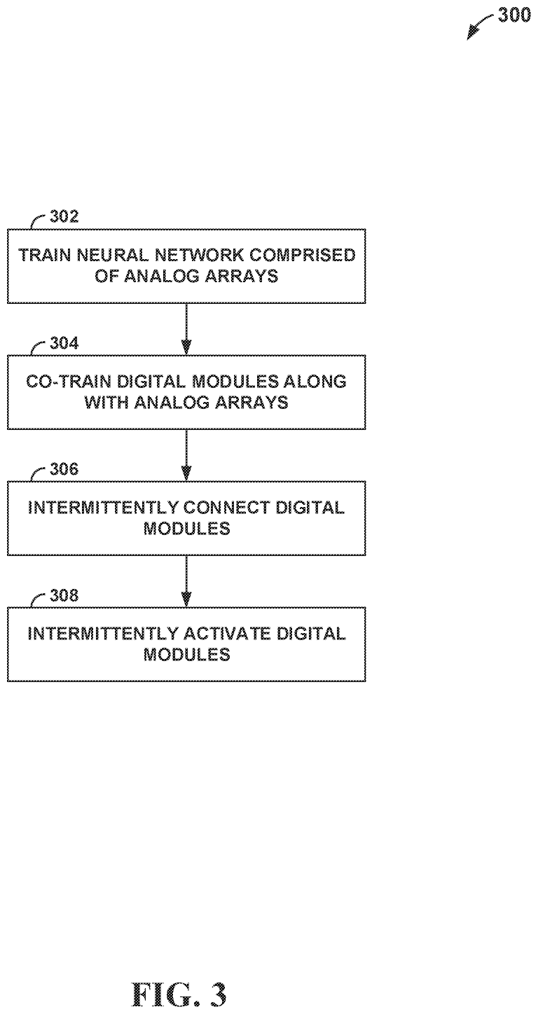

Using these components, controller 102 may connect and activate digital modules 160 of neural network 104 to correct weights of analog arrays of neural network 104 as discussed herein. For example, controller 102 may manage digital modules 160 according to flowchart 300 depicted in FIG. 3. Flowchart 300 of FIG. 3 is discussed with relation to FIG. 1 for purposes of illustration, though it is to be understood that other systems and message may be used to execute flowchart 300 of FIG. 3 in other examples. Further, in some examples controller 102 may execute a different method than flowchart 300 of FIG. 3, or controller 102 may execute a similar method with more or less steps in a different order, or the like.

Flowchart 300 starts with training neural network 104 comprised of analog arrays (302). For example, neural network may include input layer 120, hidden layers 130, and output layer 140 with plurality of neurons 110, where each of these comprise analog arrays. As described herein, synaptic weights of neural network 104 may be provided by analog arrays within these layers 120, 130, 140. Digital modules 160 are co-trained along with these analog arrays (304).

In some examples, all of neural network 104 is trained at once (e.g., digital modules 160 and all analog arrays), such that digital modules 160 are fully activated and turned on while neural network is trained. In other examples, analog arrays are trained first, following which digital modules 160 are trained and then the neural network 104 is deployed. In yet other examples, neural network is first trained digitally (e.g., using digital modules 160 and/or other digital circuitry), after which digital weights are converted into the analog arrays, after which the neural network 104 is deployed.

Controller 102 intermittently connects digital modules 160 (306). Controller 102. further intermittently activates digital modules 160 (308). Controller 102 may use digital modules 160 to correct one or more weights of the analog arrays of neural network 104 (e.g., weights of connections 150). Controller 102 may intermittently activate digital modules 160 during operation of neural network 104 in production environment 100. For example, controller 102 may activate digital modules 160 in response to detecting that a waiting period has elapsed, if an energy criterion is satisfied, and/or if the analog arrays of neural network 104 failed a performance criterion,

In some examples, functionality ascribed herein to controller 102 may be realized in whole or in part via circuitry of neural network 104. For example, activation and/or connection of digital modules 160 may be realized via logic gates (e.g., logic gates of controller 102) that connect and/or activate one or more digital modules 160 of neural network 104 as described herein.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-situation data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A system comprising:
a plurality of analog arrays that comprise all synaptic weights of a neural network; and
a plurality of digital modules that is co-trained along with the plurality of analog arrays in generating the neural network, wherein digital modules are configured to be intermittently connected within the neural network when the neural network is in a production environment.

2. The system of claim 1, wherein the plurality of digital modules is configured to correct one or more weights of the plurality of analog arrays.

3. The system of claim 1, wherein each of the plurality of digital modules are intermittently activated during operation of the neural network.

4. The system of claim 3, wherein at least one of the plurality of digital modules is configured to be activated in response to a performance criterion being failed.

5. The system of claim 3, wherein at least one of the plurality of digital modules is configured to be activated in response to a waiting period elapsing.

6. The system of claim 3, wherein at least one of the plurality of digital modules is configured to be activated in response to an energy criterion being satisfied.

7. A computer-implemented method comprising:
training a plurality of analog arrays to comprise all synaptic weights of a neural network; and
co-training a plurality of digital modules along with the plurality of analog arrays in generating the neural network, wherein the digital modules are intermittently connected within the neural network when the neural network is in a production environment.

8. The computer-implemented method of claim 7, further comprising using the plurality of digital modules to correct one or more weights of the plurality of analog arrays.

9. The computer-implemented method of claim 7, further comprising intermittently activating each of the plurality of digital modules during operation of the neural network.

10. The computer-implemented method of claim 9, further comprising detecting that the plurality of analog arrays failed a performance criterion, wherein the at least one of the plurality of digital modules is activated in response to the performance criterion being failed.

11. The computer-implemented method of claim 9, further comprising detecting that a waiting period has elapsed, wherein the at least one of the plurality of digital modules is activated in response to the waiting period elapsing.

17. The computer-implemented method of claim 9, further comprising detecting that an energy criterion is satisfied, wherein the at least one of the plurality of digital modules is activated in response to the energy criterion being satisfied.

13. The computer-implemented method of claim 7, further comprising detecting that the plurality of analog modules has been fully trained within the neural network, wherein the plurality of digital modules is co-trained in response to detecting that the plurality of analog modules has been fully trained.

14. The computer-implemented method of claim 7, wherein the plurality of digital modules and the plurality of analog arrays are co-trained together from a beginning of the neural network.

15. The computer-implemented method of claim 7, further comprising:
detecting that the neural network has been generated and trained with a set of digital modules;
transferring the neural network to the plurality of the analog arrays in response to detecting that the neural network has been generated; and
co-train the plurality of analog arrays and the plurality of digital modules to run the neural network.

16. A system comprising:
a processor; and
a memory in communication with the processor, the memory containing instructions that, when executed by the processor, cause the processor to:
train a plurality of analog arrays to comprise all synaptic weights of a neural network; and
co-train a plurality of digital modules along with the plurality of analog arrays in generating the neural network, wherein the digital modules are intermittently connected within the neural network when the neural network is in a production environment.

17. The system of claim 16, the memory containing additional instructions that, when executed by the processor, cause the processor to use the plurality of digital modules to correct one or more weights of the plurality of analog arrays.

18. The system of claim 16, the memory containing additional instructions that, when executed by the processor, cause the processor to intermittently activate each of the plurality of digital modules during operation of the neural network.

19. The system of claim 18, the memory containing additional instructions that, when executed by the processor, cause the processor to detect that the plurality of analog arrays failed a performance criterion, wherein the at least one of the plurality of digital modules is activated in response to the performance criterion being failed.

20. The system of claim 18, the memory containing additional instructions that, when executed by the processor, cause the processor to detect that a waiting period has elapsed, wherein the at least one of the plurality of digital modules is activated in response to the waiting period elapsing.
